(19) United States
(12) Patent Application Publication
(10) Pub. No.: US 2026/0020513 A1
(43) Pub. Date: Jan. 22, 2026

(54) RADIATOR SCREEN MODULE FOR AGRICULTURE MACHINES

(71) Applicant: MASCHINENFABRIK BERNARD KRONE GMBH & CO. KG, SPELLE (DE)

(72) Inventors: BORIS HAAR, FUERSTENAU (DE); VIKTOR ZIRKE, METTINGEN (DE); TOBIAS HARPERT, LEGDEN (DE)

(73) Assignee: MASCHINENFABRIK BERNARD KRONE GMBH & CO. KG, SPELLE (DE)

(21) Appl. No.: 19/188,029

(22) Filed: Apr. 24, 2025

(30) Foreign Application Priority Data
Apr. 29, 2024 (DE) 10 2024 112 001.0

(51) Int. Cl. A01B 71/08; B08B 5/04

(52) U.S. Cl. CPC A01B 71/08; B08B 5/04

(57) ABSTRACT

A radiator screen assembly for an agricultural machine includes a frame, a screening chamber which is at least partially surrounded by the frame, a screen arranged in the screening chamber, a cleaning unit which cleans the screen, and a drive unit. The screening chamber has cooling air passed therethrough. The cleaning unit has a runner unit(s) mounted on the frame to be translationally displaceable along a running direction and to extend transversely to the running direction. The drive unit oscillates the runner unit(s) in the running direction. The drive unit includes an actuator and a coupling lever having a runner arm(s). The coupling lever pivots about a pivot axis of a coupling which is stationary relative to the frame and which is coupled to the actuator in a drive-transmitting manner. The runner arm(s) of the coupling lever is coupled to the runner unit(s) in a drive-transmitting manner.

### CROSS REFERENCE TO PRIOR APPLICATIONS

Priority is claimed to German Patent Application No. DE 10 2024 112 001.0, filed Apr. 29, 2024. The entire disclosure of said application is incorporated by reference herein.

### FIELD

The present invention relates to a radiator screen assembly.

### BACKGROUND

Agricultural machinery such as forage harvesters have different components which need to be cooled during operation, e.g., a drive motor, a gear, etc. The heat from such a component to be cooled is typically transferred to a coolant, which then releases it to the ambient air in a radiator. To enable sufficient heat exchange, the ambient air is drawn in by a radiator fan and guided along the radiator. The ambient air drawn in is, however, often heavily contaminated by the harvesting process, for example, by whirled up dust, crop residues or similar. To prevent these contaminants from clogging the radiator and reducing its cooling capacity, the ambient air is drawn in through a radiator screen which retains particles above a certain minimum size.

The radiator screen itself can, however, also become clogged within a short time due to the trapped particles. When cutting and/or processing, the crop also releases liquids containing in particular sugar which can stick to the radiator screen. Such radiator screens are therefore often designed to fold-out to make them easier to clean. In order to provide cleaning during field operation, it is also known to provide the agricultural machine with an automatic cleaning system which cleans the screen during operation. Such a cleaning system typically has a suction unit which uses negative pressure to extract dirt from the radiator screen. In order not to excessively impair the air flow, the suction unit only covers a small part of the screen and must therefore be guided over the screen to successively clean different areas.

Although suction units with a translational movement have already been proposed in some cases, the suction unit in many prior art systems is rotationally driven. This makes it impossible to adequately clean a rectangular screen. This would, however, be desirable due to the often rectangular cross-section of the associated radiator. The systems known in the prior art also often require suspension in front of a central area of the screen which disrupts the air flow that is normally there the strongest. The drive components or suspension components of the cleaning unit can furthermore impair the tightness of the assembly. This means that gaps can occur through which contaminated air can get past the screen to the radiator, or cooling air can escape, thereby reducing the cooling capacity.

DE 10 2018 006 701 A1 describes a self-propelled harvesting machine with a radiator unit which is protected from contaminants by a filter device with an air-permeable filter element. The filter element consists of several parts. A guide of a cleaning device divides the filter element into two sections, in each of which a filter segment is arranged. The cleaning device has a suction device which can be moved translationally along the guide.

EP 1 262 645 B1 describes a self-propelled harvesting machine with a cooling unit and a cleaning device for the cooling air drawn in. The cleaning device has a round screening device which is positioned upstream of the cooling unit and can be set in a rotational movement, as well as a suction fan which is designed to extract the air from the screening device. The cooling unit is rectangular in shape so that the screen surface does not completely cover the cooling unit.

EP 2 546 492 B1 describes a rectangular material collecting screen with a screen cleaning arrangement. A hollow arm, which is connectable to a vacuum source, is movable over a surface of the screen, wherein the hollow arm has an opening in a first side which is adjacent to a surface of the screen. The arm has an inner arm which can be pivoted by a motor and an outer arm which can be moved radially relative to the inner arm.

EP 2 754 873 B3 describes an intake system for cooling air which has a rectangular screen. The intake system has a suction device for cleaning the screen. The screen can in particular be rectangular and be accommodated by frame parts of a receiving housing, wherein the suction device is guided as a carriage via a linear guide system relative to the screen.

EP 3 586 595 B1 describes a radiator basket with a cleaning device which has two suction arms which can be moved over the surface and which can be pivoted about diagonally opposite bearing points with respect to a rectangular surface of the radiator basket.

### SUMMARY

An aspect of the present invention is to optimize the cleaning of a radiator screen on an agricultural machine.

In an embodiment, the present invention provides a radiator screen assembly for an agricultural machine which includes a frame, a screening chamber which is at least partially surrounded by the frame, a screen arranged in the screening chamber to extend along a screen surface, a cleaning unit which is configured to clean the screen, and a drive unit. The screening chamber is configured to have a cooling air be passed therethrough in a direction of passage from an ambient side to a radiator side. The cleaning unit comprises at least one runner unit which is mounted on the frame so as to be translationally displaceable along a running direction and so as to extend transversely to the running direction in a width direction. The drive unit is configured to oscillate the at least one runner unit in the running direction. The drive unit comprises an actuator and a coupling lever which comprises at least one runner arm. The coupling lever is configured to pivot about a pivot axis of a coupling which is stationary relative to the frame and which is coupled to the actuator in an at least indirect drive-transmitting manner. At least one of the at least one runner arm of the coupling lever is coupled to the at least one runner unit in an at least indirect drive-transmitting manner.

### BRIEF DESCRIPTION OF THE DRAWINGS

The present invention is described in greater detail below on the basis of embodiments and of the drawings in which:

FIG. 1 shows a schematic side view of an agricultural machine according to the present invention;

FIG. 2 shows a front view of a first embodiment of a radiator screen assembly according to the present invention;

FIG. 3 shows a first perspective view of the radiator screen assembly from FIG. 2;

FIG. 4 shows a second perspective view of the radiator screen assembly from FIG. 2;

FIG. 5 shows a sectional view of a detail of the radiator screen assembly from FIG. 2;

FIG. 6 shows perspective detail views of the radiator screen assembly from FIG. 2;

FIG. 7 shows a perspective view of a second embodiment of a radiator screen assembly according to the present invention with two screen elements;

FIG. 8 shows a perspective view of a third embodiment of a radiator screen assembly according to the present invention; and

FIG. 9 shows a front view of a fourth embodiment of a radiator screen assembly according to the present invention.

### DETAILED DESCRIPTION

The present invention provides a radiator screen assembly for an agricultural machine, having a frame which at least partially surrounds a screening chamber, through which cooling air can be passed in a direction of passage from an ambient side to a radiator side and in which a screen extending along a screen surface can be accommodated, having a cleaning unit for cleaning the screen, having at least one runner unit which is mounted on the frame so as to be translationally displaceable along a running direction and extends transversely to the running direction in a width direction, and having a drive unit which has an actuator and via which at least one runner unit can be driven to oscillate in the running direction.

The radiator screen assembly is designed for an agricultural machine, wherein the agricultural machine may in particular be a self-propelled harvesting machine or a tractor. Such a tractor can be combined with an attachment or pull a processing device without its own power drive so that it can itself be used for field processing.

The radiator screen assembly is assigned to a radiator screen and can optionally also include the radiator screen. The aforementioned radiator screen and thus also the radiator screen assembly serve to clean a cooling air flow which is fed to a radiator. Plant parts and other particles carried in the air stream are at least partially retained in the screen. The radiator is normally designed to cool a coolant by transferring heat to the cooling air flow, wherein the coolant has previously absorbed heat from a component of the agricultural machine to be cooled, e.g., from a drive motor or a gear. The term “cooling air” is not to be interpreted as limiting the temperature or other properties of the air, but merely indicates that the air is designed to absorb heat from the radiator. The cooling air can also be referred to as ambient air.

The assembly has a frame which at least partially surrounds a screening chamber through which cooling air can be passed in a direction of passage from an ambient side to a radiator side. The frame can also be referred to as a housing, at least in some embodiments. The frame surrounds the screening chamber at least partially, usually completely. The radiator side is the side which, if installed, is arranged closer to the radiator in relation to the flow path, while the ambient side is the side which faces the surroundings of the agricultural machine in relation to the flow path. Ambient air flows into the screening chamber from this side. In the following, “ambient side” means “on the ambient side” and “radiator side” means “on the radiator side”. Although this is not essential to the present invention, the cooling air flow is usually generated by a radiator fan or a suction fan. The screening chamber serves to allow the cooling air to pass through. A screen can be accommodated in the screening chamber. The screen, which can also be referred to as a radiator screen, can be designed as a single or multiple part. In the latter case, the screen consists of a plurality of screen elements. The frame can have holding, fastening and/or guide elements which support the insertion and/or securing of the screen in a designated position. If installed, the screen extends along a screen surface. The screen surface is determined by the geometry of the screen and by its installation position within the frame. A specific course of the screen surface is provided, which can also be defined when the screen is not in use. The screen can, for example, be designed to be rectangular. The same applies, where applicable, to individual screen elements. The screen surface can also, for example, be designed to be flat and can therefore also be referred to as a screen level.

The assembly also features a cleaning unit for cleaning the screen. “Cleaning” here primarily refers to the removal of contaminants, e.g., plant parts or other particles, from the screen. The cleaning unit in turn has at least one runner unit which is mounted on the frame so as to be translationally displaceable along a running direction and extends transversely to the running direction in a width direction. A plurality of runner units can also be provided, in particular two runner units. As part of the cleaning unit, the function of the runner unit is related to the cleaning of the screen. This can refer directly to cleaning, but it can also refer, for example, to an auxiliary function which supports cleaning. The respective runner unit can be moved translationally on the frame, wherein the direction of movement is referred to here as the running direction. Although it would be conceivable within the scope of the present invention for the running direction to vary locally, thus allowing the runner unit to be displaced translationally along, for example, a slightly curved path, it can, for example, be displaceable in a straight line along the running direction. This means that the running direction can, for example, be the same in all parts of the frame. To support the translational displacement, the frame can have a guide structure which interacts with a corresponding guide structure of the runner unit. The runner unit can in particular have at least one rolling element, for example, a roller, which rolls on a guide rail of the frame. In an embodiment of the present invention, the runner unit can, for example, be guided during translational movement.

The respective runner unit extends transversely to the running direction in a direction which is referred to here and in the following as the width direction. This means that the running direction and the width direction run at right angles to each other. Without being limited thereto, when installed, the running direction can in particular be aligned parallel to the vertical axis of the agricultural machine so that the width direction is aligned horizontally. The extension of the runner unit in the width direction can, for example, correspond to at least three times or more of its extension in the running direction. The extension in the width direction can, for example, also correspond to at least 90% or more of an extension of the screen. This allows the runner unit to cover the screen completely or almost completely in the width direction. The extension of the runner unit in the running direction can, for example, correspond to a maximum of 25% or less of the extension of the screen. This means that, for example, only a comparatively small part of the screen is covered so that the cooling air flow is only slightly disturbed.

The assembly also has a drive unit which has an actuator and via which at least one runner unit can be driven in an oscillating manner in the running direction. Although reference is made here to “one” actuator, it is conceivable that the drive unit has a plurality of actuators. Exactly one actuator can, for example, be provided. The drive unit can drive at least one runner unit so that it oscillates in the running direction, i.e., back and forth. In temporal sequence, the corresponding runner unit first moves in one direction, then in the opposite direction, etc. This can, for example, apply to each runner unit in the case of multiple runner units. The temporal sequence of the individual movement parts can be selected differently, for example, with or without an intermediate standstill of the runner unit. The movement range can, for example, be selected so that the runner unit covers at least 90% or more of the screen in the running direction. This means that even with a comparatively small extension of the runner unit, a complete or an almost complete cleaning can be achieved.

According to the present invention, the drive unit has a coupling lever which is pivotable about a pivot axis of the coupling which is stationary relative to the frame and which coupling lever is coupled to the actuator in an at least indirect drive-transmitting manner, wherein at least one runner arm of the coupling lever is coupled to a runner unit in an at least indirect drive-transmitting manner. The pivot axis of the coupling can be implemented by a suitable pivot bearing of the coupling. The pivot axis can, for example, run in the direction of passage and/or perpendicular to the screen level and/or perpendicular to the running direction and to the width direction. The coupling lever establishes a simple but effective mechanical connection through which a drive movement of the actuator can be transmitted directly or indirectly via at least one intermediate element to the respective runner unit. The coupling lever has a runner arm which is coupled directly or indirectly to the runner unit in a drive-transmitting manner. The oscillating translational movement of the runner unit is thus guided at least indirectly by the aforementioned runner arm. The runner arm is part of the coupling lever and can therefore be pivoted around the pivot axis of the coupling. The drive unit can, for example, be designed to pivot the coupling lever (including the runner arm) oscillating around the pivot axis of the coupling. The drive unit therefore causes the translational movement of the runner unit via the pivoting movement of the coupling lever.

A wide-ranging movement of the runner unit can be generated via the runner arm without necessarily requiring a wide-ranging movement of the actuator. The required installation space can therefore be comparatively small. The screen surface can be covered substantially completely via the running unit without having to divide the screen.

In order to achieve a large movement range, the runner arm can, for example, have a length which corresponds to between 50% and 100% of a diagonal of the screen. The respective runner arm can, for example, extend along the screen level, i.e., either on the ambient side or on the radiator side. The pivoting movement of the runner arm is transmitted into the translational movement of the runner unit. There are different ways of providing therefor, some of which are discussed below.

The cleaning unit can, for example, have a suction runner unit comprising a suction unit which is designed to be connected to a vacuum source, which is arranged on the ambient side of the screen surface. The suction runner unit is a runner unit with the properties described above. The suction runner features a suction unit which is designed to be connected to a vacuum source. The suction unit can be connected to the vacuum source via a flexible connecting hose. The vacuum source, which can also be referred to as a negative pressure source, can also be part of the agricultural machine. The suction unit is arranged on the ambient side of the screen level, which can also apply to the entire suction runner unit. The suction unit is used to suck plant parts and other dirt from the screen. The suction unit extends transversely to the running direction in the width direction. The extension of the suction unit in the width direction can, for example, correspond to at least three times or more of its extension in the running direction. The extension in the width direction can, for example, additionally correspond to at least 90% or more of an extension of the screen. In the running direction, the extension of the suction unit can, for example, correspond to a maximum of 25% or less of the extension of the screen. The suction unit may have a suction cover or a suction housing which is open towards the screen level but which is otherwise at least predominantly closed. This suction cover defines the area in which an effective suction effect can be exerted.

The suction runner arm of the coupling lever extending on the ambient side of the screen surface can, for example, be coupled at least indirectly in a drive-transmitting manner to the suction runner unit. The suction runner arm is part of the coupling lever and is a runner arm with the properties described above. The suction runner arm extends on the ambient side of the screen level, i.e., in an area which does not need to be protected from contaminants. The arrangement and operation of the runner arm therefore do not increase the risk of contaminants penetrating the area on the radiator side. The pivoting movement of the suction runner arm is transmitted into the translational movement of the suction runner unit.

In addition to the suction unit, the suction runner unit can have further elements, in particular at least one brush element. The brush element can increase the suction effect by bridging a given distance between the suction unit and the screen in the direction of passage. A brush element can therefore in particular be arranged on the edge of the suction unit, e.g., on the edge of the above-mentioned suction cover. A brush element can above all be used to mechanically act on contaminants on the screen and loosen them so that they can be more easily extracted by the suction unit.

The pivot axis of the coupling can, for example, be offset relative to the screening chamber. This means that the pivot axis of the coupling is neither arranged in the screening chamber nor aligned therewith in the direction of passage. This means that neither the structure of the screen nor the cooling air flow is disturbed by a pivot bearing or other components of the pivot axis of the coupling. The pivot axis of the coupling can be offset in the running direction to the screening chamber. The pivot axis can, for example, be offset in the width direction to the screening chamber. The pivot axis of the coupling can, for example, be arranged on an outside of the frame opposite the screening chamber. The frame surrounds the screening chamber completely or partially so that the screening chamber is arranged on an “inside”. The opposite side of the frame is referred to here and below as the “outside”. This external arrangement avoids potential sealing problems associated with the pivot axis of the coupling.

Due to the strength of the cooling air flow, effective suction of the screen from the ambient side is difficult or even impossible if the suction unit must work against the cooling air flow. It is therefore advisable or necessary to shield the cooling air flow locally where the suction unit operates. This can be provided using a so-called shielding element. In an embodiment of the present invention, the cleaning unit can, for example, have a shielding runner unit with a flat shielding element which is arranged opposite the suction unit on the radiator side of the screen surface. In an embodiment of the present invention, a movement of the shielding runner unit along the running direction can, for example, be positively coupled by the drive unit to the movement of the suction runner unit. If a screen is installed, the screen is positioned between the ambient-side suction unit and the radiator-side shielding element. The shielding element, which can be formed, for example, by a sheet metal part, at least partially shields the cooling air flow so that the suction unit can work effectively. A cross-section of the shielding element can, for example, correspond to at least one cross-section of the suction unit, or, if necessary, it can also be slightly larger. The movements of the shielding element and suction unit should be synchronized to provide an effective shielding. In this embodiment, this is achieved by the movement of the shielding runner unit being positively coupled by the drive unit to the movement of the suction runner unit. The shielding runner unit is accordingly also driven by the drive unit.

The shielding runner unit can in principle be driven in different ways. The coupling lever can, for example, have a shielding runner arm which is coupled at least indirectly to the shielding runner unit in a drive-transmitting manner. The shielding runner arm can, for example, extend on the radiator side of the screen level, wherein coupling to the shielding runner unit can be optimally realized. If a suction runner arm as described above is also present, the shielding runner arm is connected thereto in a rotationally fixed manner, i.e., in particular rotationally fixed with respect to the pivot axis of the coupling. The suction runner arm and the shielding runner arm can be designed as a single piece or directly connected to each other. They can, for example, be connected by an axle pin which is arranged coaxially with the pivot axis of the coupling and is mounted so as to be pivotable relative to the frame. Both the suction runner unit and the shielding runner unit can, for example, be driven by an associated runner arm. The drive transmission from the suction runner arm to the suction runner unit can be performed in the same way as the drive transmission from the shielding runner arm to the shielding runner unit. Different principles can, however, also apply.

At least one runner unit can, for example, be mounted on the frame on both sides at the ends via side sections in relation to the width direction. This means that the runner unit is mounted in a displaceable manner on two areas of the frame that are opposite each other in the width direction, wherein one side section of the runner unit on the one hand and the other side section of the runner unit on the other hand is mounted on the frame. Rails can, for example, be provided therefor in the opposite areas. This provides a stable guide and prevents an unintentional twisting of the runner unit. A central section of the runner unit located between the side sections has no direct contact with the frame, i.e., it is supported and guided on the frame only via the end areas on both sides and, under certain circumstances, also via the drive unit. This means that there are no frame-side guide structures on the ambient side or radiator side of the screening chamber. Such guide structures would obstruct the air flow. They could form possible gaps or weak points with regard to the penetration of contaminants. This is prevented by the end guide on both ends. The drive unit can advantageously be coupled to the central section in a drive-transmitting manner. This means that the mechanical connection between the drive unit and the runner unit is made via the central section. The runner arm belonging to the runner unit can in particular be coupled directly or indirectly to the central section.

The pivoting movement of a runner arm must be transmitted into the translational movement of the associated runner unit. This can be provided in different ways. One embodiment provides that at least one runner arm and a runner unit associated therewith cooperate via a displacement element and a guide element, which guide element defines a displacement path which extends at an angle to the running direction and along which the displacement element is displaceably guided. The assigned or associated runner unit is, of course, the one to which the respective runner arm is coupled in a drive-transmitting manner, i.e., for example, in the case of the suction runner arm, the suction runner unit. The displacement element can be moved along the guide element in a guided manner. The displacement element can, for example, slide along the guide element or have one or more rolling elements that roll on the displacement element. The guide element forms a partial positive fit with the displacement element which enables movement with exactly one translational degree of freedom. The displacement element can, however, additionally be rotated relative to the guide element. The guide path defined by the guide element can, in particular be straight. Other courses are, however, also possible, for example, curved or angled courses. The guide element can in particular have a guide slot into which the displacement element engages.

According to one embodiment of the present invention, the runner arm can have the displacement element and the guide element can be arranged stationary on the runner unit. According to another embodiment, the runner unit has the displacement element and the guide element is arranged stationary on the runner arm. Both of the above embodiments can be advantageous. It is also possible to combine the two embodiments. For example, one runner arm (e.g., the suction runner arm) could have a displacement element and the associated runner unit could have a guide element, while the other runner arm (e.g., the suction runner arm) could have a guide element and the associated runner unit could have a displacement element.

Another option is for at least one runner arm to be designed telescopically and be connected to the associated runner unit via a pivot bearing. The pivot bearing, which can be referred to as the pivot bearing of the runner arm, is fixed to the runner unit. It can be designed simply, for example, as a plain bearing. While the pivot bearing compensates for the relative rotation between the runner arm and the runner unit, the changing distance between the pivot bearing and the pivot axis of the coupling is compensated for by the telescoping design of the runner arm. The runner arm can have two or more arm elements that can be pushed into each other. It is understood that telescoping and the associated change in length are passive and result from the pivoting movement of the coupling lever and the guide of the runner unit on the frame.

The introduction of a torque into the coupling lever, which results in the pivoting movement thereof, can take place in different ways. A rotary actuator could, for example, act coaxially to the pivot axis of the coupling. A gearwheel could also be connected to the coupling lever in a rotationally fixed manner on which the actuator acts via another gearwheel or a rack. An embodiment provides, however, that the coupling lever can, for example, have an actuator arm which is connected in a rotationally fixed manner to the at least one runner arm and is coupled at least indirectly to the actuator. The rotationally fixed connection of the mentioned runner arms can be realized by a one-piece embodiment. In another embodiment, however, the rotationally fixed connection of the runner arms can, for example, also comprise two separately prefabricated components. These can be connected to each other directly or, for example, via one of the axle pins mentioned above.

The actuator is advantageously designed as a linear actuator. It can, for example, be designed as an electric, hydraulic, electrohydraulic or pneumatic linear actuator. The end positions of the linear actuator ideally correspond to the end positions of the at least one runner unit so that the linear actuator can be contracted and expanded to the maximum extent. If this is not the case, the linear actuator can be controlled by detecting the end positions of the runner unit via sensors, for example, contact sensors. Such sensors can be arranged on the outside of the frame. They can in particular interact with the actuator arm so that they detect its position on behalf of the position of the runner unit.

The linear actuator can interact with the coupling lever in different ways, wherein the linear movement of the linear actuator is transmitted into a rotational movement of the coupling lever. Different mechanical solutions are conceivable for this purpose and are in principle known. The linear actuator can, for example, be pivotably connected to the frame and be pivotably connected to the actuator arm. This means that the linear actuator is connected to the frame via a first actuator pivot bearing and to the actuator arm via a second actuator pivot bearing. The pivot bearings mentioned can be arranged stationary on the frame and on the actuator arm. The pivoted connections allow the linear actuator to follow the pivoting movement of the coupling lever. With a suitable design of the linear actuator, the distance between the second actuator pivot bearing and the pivot axis of the coupling (and thus the effective length of the actuator arm) can be only a fraction of the length of the runner arm, for example, a maximum of 20% or a maximum of 10%. One advantage of the interaction between the linear actuator and the actuator arm can be that the linear movement of the actuator is transmitted into a further linear movement of the runner unit via the pivoting movement of the actuator arm and the suction runner arm or the shielding runner arm. This means that the movement of the runner unit can be roughly proportional to the movement of the linear actuator, even if not exactly. This means that at a constant movement speed of the linear actuator, the movement speed of the runner unit is approximately constant. The latter in turn provides that all areas of the screen are cleaned at least similarly thoroughly.

One embodiment of the present invention provides that at least one runner arm, for example, the shielding runner arm, is guided through a frame port in the frame. This is due to the fact that the coupling pivot axis can, for example, be arranged outside the frame in the width direction. Since the frame should have a certain depth in the direction of passage for stability reasons, it is structurally difficult to guide each of the runner arms past the front or rear of the frame. This is easily achievable for the suction runner arm, but not for the shielding runner arm. The shielding runner arm can in particular be guided through the mentioned frame port from the outside of the frame to the inside. As the frame port generally allows particles to penetrate, its dimensions should be kept small while still allowing an unhindered pivoting movement of the runner arm. The pivot axis of the coupling can, for example, be arranged close to the frame. This means that the pivoting angle traversed by the coupling lever in the area of the frame when the coupling lever is pivoted is small so that the required frame port can be designed correspondingly small.

Although the frame port can be comparatively small, it represents a potential weak point with regard to the penetration of contaminants. A slider element can, for example, be arranged on the frame so as to be displaceable in the running direction, which slider element partially covers the frame port and has a slider port through which the runner arm is guided. The slider element is designed to seal the frame in the area of the frame port. The slider element can, for example, be formed by a flat sheet metal or plastic part. It can be displaced on the frame in the running direction, for which purpose the frame can have simple guide elements on the side of the frame port, which guide elements engage with the slider element. The slider element can, for example, be positively guided via the guide elements. The slider element can be arranged on the inside, i.e., facing the screening chamber, or on the outside, i.e., on a side of the frame facing away from the screening chamber.

The slider element can, for example, cover at least most of the frame port and can, for example, have the slider port through which the runner arm is guided. If the slider element is displaceable relative to the frame, it can be displaced, in particular driven, by the runner arm during its pivoting movement without impeding this movement. The extension of the slider port in the running direction therefore need not correspond to the entire movement range of the runner arm, but must substantially correspond to or be only slightly larger than an extension of the runner arm, in contrast to the frame port. The slider port can, for example, therefore have a smaller extension in the running direction than the frame port. This can be measured at the cross section of the runner arm in the plane of the slider element, relative to the end position of the runner arm. This leaves only (very) small spaces between the slider port and the runner arm so that the passage cross-section for dirt particles can be reduced to a fraction compared to the one in an embodiment without a slider element. Due to the very small extension of the slider port, only a very small amount of cooling air can be lost through the frame port or the slider port. The radiator screen assembly therefore has virtually no effect on the cooling capacity.

Despite regular cleaning by suction and/or brushing of the screen, it may be necessary from time to time to clean the screen more thoroughly and/or more effectively. The screen can, for example, be designed to be removable from the frame in a reversible manner. The frame can, for example, have at least one lateral insertion opening therefor through which at least one screen element of the screen can be inserted, for example, by sliding, into the screening chamber. The insertion opening makes it very easy to remove and reinsert the screen. This makes it possible to clean the screen outside the assembly, for example, with a high-pressure cleaner.

The screen can consist of a single screen element or have a plurality of screen elements. The insertion opening is located on the side of the frame. It is dimensioned so that the screen element can be guided into and out of the screening chamber. The screen element can be designed so that, when inserted, it closes the insertion opening to prevent the penetration of crop or dirt particles and/or the escape of cooling air through the insertion opening. When inserting or removing the screen element, it moves along the screen surface so that it cannot collide with the suction unit located on the ambient side, the suction runner arm, the shielding element located on the radiator side, or the shielding runner arm. A separate insertion opening can be provided for each screen element. The insertion opening can, for example, be arranged laterally in the width direction and to extend in the running direction.

The frame can in particular have two insertion openings which are offset relative to one another in the running direction, wherein the pivot axis of the coupling is arranged between the insertion openings with respect to the running direction. This is in particular necessary if the shielding runner arm is connected to the suction runner arm in the area of the pivot axis of the coupling. A corresponding connection, for example, via an axle pin, must lead from the ambient side to the radiator side, which could potentially lead to a collision with a screen element. However, if the pivot axis of the coupling is arranged between two insertion openings, the associated screen elements can be guided past on both sides without any problems.

The present invention also provides an agricultural machine which in particular has such a radiator screen assembly, a frame which at least partially surrounds a screening chamber, through which cooling air can be passed in a direction of passage from an ambient side to a radiator side and in which a screen extending along a screen surface can be accommodated, having a cleaning unit for cleaning the screen, at least one runner unit which is mounted on the frame so as to be translationally displaceable along a running direction and extends transversely to the running direction in a width direction, and a drive unit which has an actuator and via which at least one runner unit can be driven to oscillate in the running direction.

According to the present invention, the drive unit has a coupling lever which is pivotable about a pivot axis of the coupling which is stationary relative to the frame and which coupling lever is coupled to the actuator in an at least indirect drive-transmitting manner, wherein at least one runner arm of the coupling lever is coupled to a runner unit in an at least indirect drive-transmitting manner.

The agricultural machine can, for example, have a component such as a drive motor and/or a gear which must be cooled during operation. The radiator screen assembly is designed to clean a cooling air flow which is fed to a radiator for cooling the component.

Since a cutting mist consisting of crop particles and liquids only occurs in field operation, i.e., during harvesting, the screen can, for example, be cleaned via the oscillating movement of the coupling lever only during field operation.

The terms mentioned have already been explained with reference to the radiator screen assembly according to the present invention and are therefore not explained again. Embodiments of the agricultural machine according to the present invention correspond to those of the radiator screen assembly according to the present invention.

The present invention is described below with reference to drawings. The drawings are merely examples and do not thereby limit the general scope of the present invention.

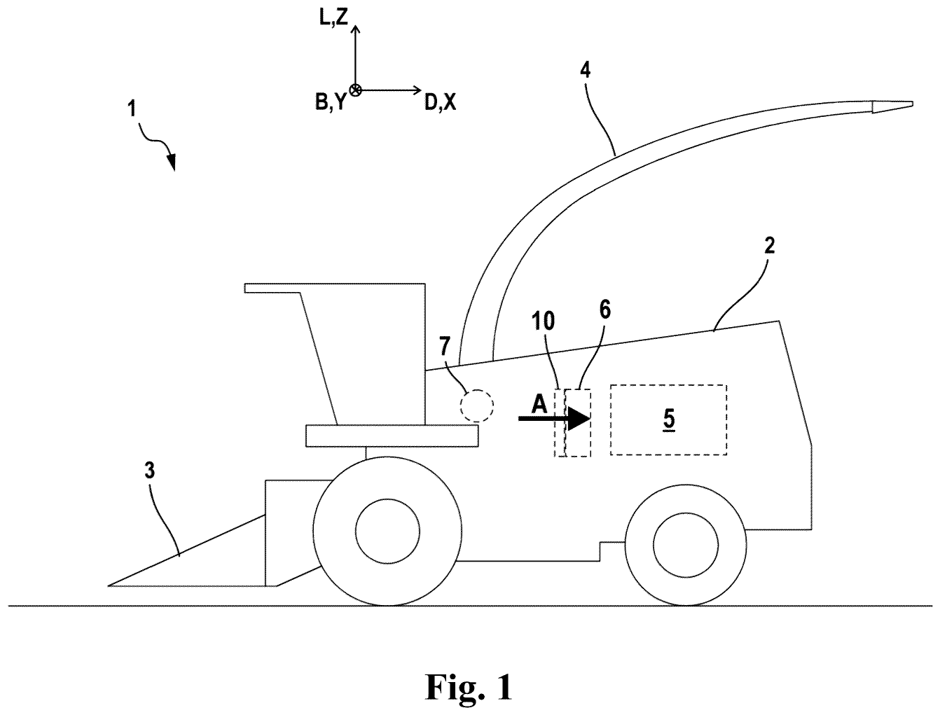

FIG. 1 shows, in a highly schematic form, an agricultural machine 1 according to the present invention, in this case a forage harvester. A harvesting header 3, for example, a corn header, is arranged on a vehicle body 2 at the front with respect to a longitudinal axis X. The crop picked up by the harvesting header 3 is shredded and processed in several steps before it is ejected by a spout 4, for example, onto an accompanying vehicle (not shown). The agricultural machine 1 has a drive motor 5 which provides the drive power for a chassis, for the harvesting header 3, and for further components. The drive motor 5 and other systems must be cooled during operation. Heat is thus transferred to a coolant of a cooling circuit (not shown), wherein the coolant can in turn transfer the absorbed heat to cooling air A in a radiator 6, which is taken from the environment and passed past the radiator 6. This is supported by a suction fan (not shown). To prevent the radiator 6 from becoming blocked by crop particles and other contaminants in the cooling air A, a radiator screen assembly 10 is installed upstream of the radiator 6. The cooling air A passes through the radiator screen assembly 10 in a direction of passage D, which in this embodiment coincides with the longitudinal axis X. A running direction L corresponds to a vertical axis Z, and a width direction B corresponds to a transverse axis Y. In other embodiments, however, this correspondence need not be the case.

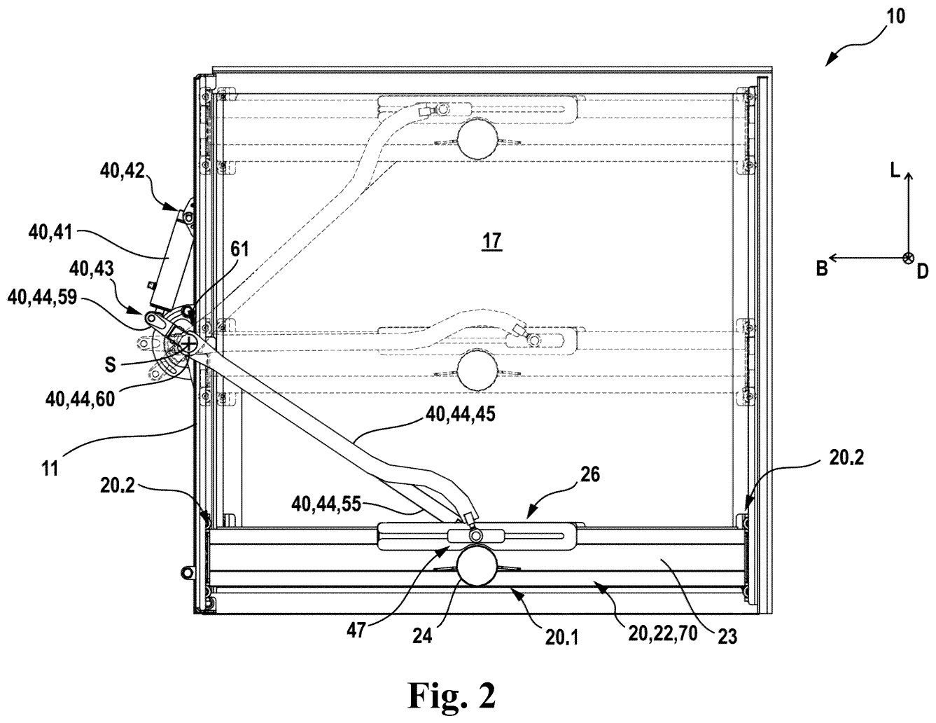

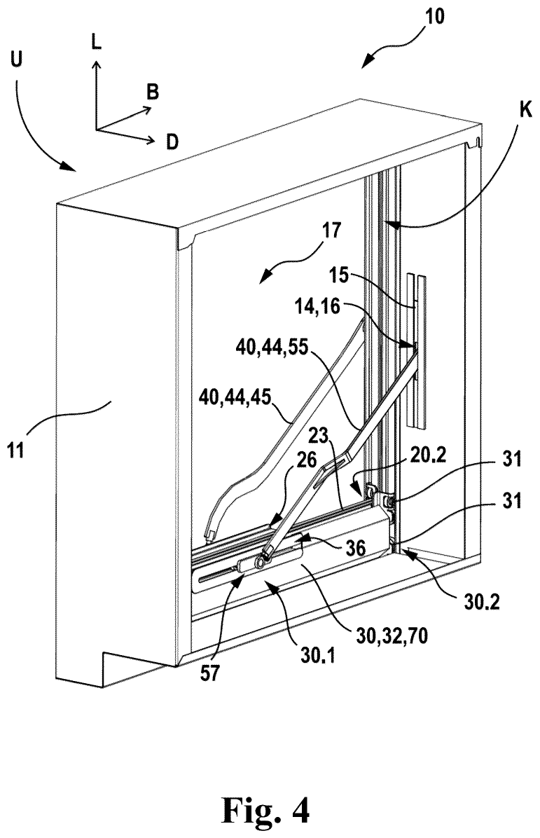

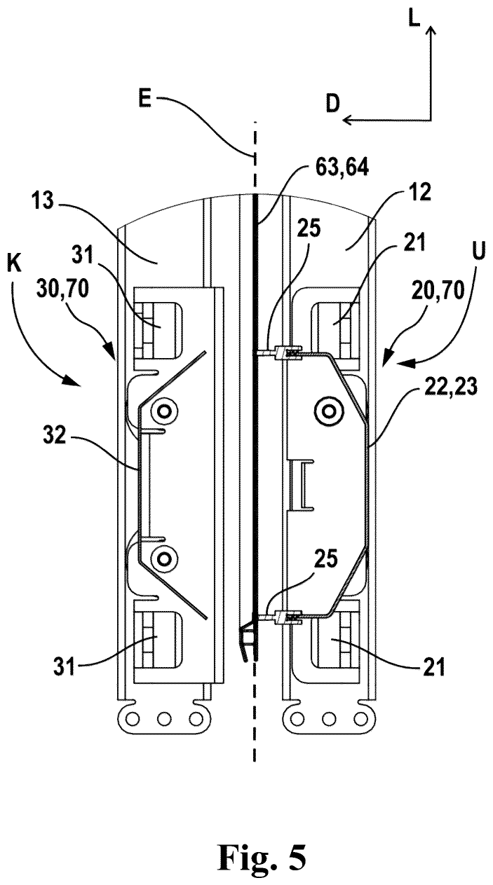

FIGS. 2-6B show a first embodiment of a radiator screen assembly 10 according to the present invention. The first embodiment has a frame 11 made of sheet steel. The frame 11 surrounds a screening chamber 17 which is intended to accommodate a screen 63. The screen 63 is shown only in FIG. 5, together with a screen surface or screen level E, along which the screen 63 extends when inserted. The screen level E runs parallel to the running direction L and to the width direction B. In the shown embodiment, the screening chamber 17 has an approximately square cross-section, which is evident in particular in the front view in FIG. 2. Cooling air A can pass through the screening chamber 17 in the direction of passage D from an ambient side U to a radiator side K. Contaminants in screen level E are filtered out of the cooling air A if the strainer 63 is inserted, as described above. To prevent clogging of the screen 63, a cleaning unit 70 is provided with a suction runner unit 20 and a shielding runner unit 30. The suction runner unit 20 is mounted on the frame 11 so that it can be displaced translationally along the running direction L. The frame 11 has a pair of first guide rails 12 therefor which run parallel to the running direction L and lie opposite each other with respect to the width direction B. At each of two side sections 20.2 arranged at the ends in relation to the width direction B, the suction runner unit 20 has a plurality of rollers 21 which cooperate with one of the first guide rails 12 to provide a precise and low-friction guide. A central section 20.1 extending between the side sections 20.2 has no direct contact with the frame 11. A drive unit 40, which will be explained in detail below, is designed to drive the suction runner unit 20 in an oscillating manner in the running direction L.

The suction runner unit 20 in particular has a suction unit 22 which is arranged on the ambient side of the screen level E and extends in the width direction B. If installed, the suction unit 22 is connected to a vacuum source 7 via a connecting piece 24 and a flexible hose (not shown). The vacuum source 7 can, for example, be a post-accelerator assigned to the spout 4. As can in particular be seen in the sectional view in FIG. 5, the suction unit 22 has a suction cover 23 which is open towards the screen level E. Brush elements 25 are attached to the suction cover 23 at the edges, which are in contact with the surface of the screen 63. They serve to seal and thus improve the suction effect and act mechanically on the surface of the screen 63 if the suction runner unit 20 moves along the running direction L and help to loosen contaminants. The suction cover 23 of the suction unit 22 extends in the width direction B practically over the entire width of the screening chamber 17 and of a screen 63 to be inserted therein. In running direction L, however, the extension of the suction cover 23 only corresponds to approximately 10% of the extension of the screening chamber 17.

A shielding element 32 of the shielding runner unit 30 is arranged with respect to the screen level E opposite the suction unit 22, and thus on the radiator side. Its cross-sectional area perpendicular to the direction of passage D is approximately identical to that of the suction cover 23. The shielding element 32 can also be referred to as a shielding plate or shadow plate. The movement of the shielding runner unit 30 is positively coupled to that of the suction runner unit 20, as will be explained below. The shielding runner unit 30 is mounted on the frame 11 so that it can be displaced translationally along the running direction L, for which purpose the frame 11 has a pair of second guide rails 13 which run parallel to the running direction L and lie opposite each other with respect to the width direction B. At each of two side sections 30.2 arranged at the ends in relation to the width direction B, the shielding runner unit 30 has a plurality of rollers 31 which cooperate with one of the second guide rails 13. A central section 30.1 extending between the side sections 30.2 has no direct contact with the frame 11.

The drive unit 40 has an actuator 41, which is in this case designed as a hydraulic cylinder. The actuator 41 is in this case therefore designed as a linear actuator. It is mounted on the outside of the frame 11 via a first actuator pivot bearing 42. It is pivotably connected to an actuator arm 59 of a coupling lever 44 via a second actuator pivot bearing 43. The coupling lever 44 has an axle pin 60, via which it is connected to the frame 11 via a pivot bearing of the coupling 61. More precisely, it can be pivoted about a pivot axis S of the coupling which is perpendicular to the running direction L and to the width direction B. The pivoting movement of the coupling lever 44 therefore runs parallel to the screen level E.

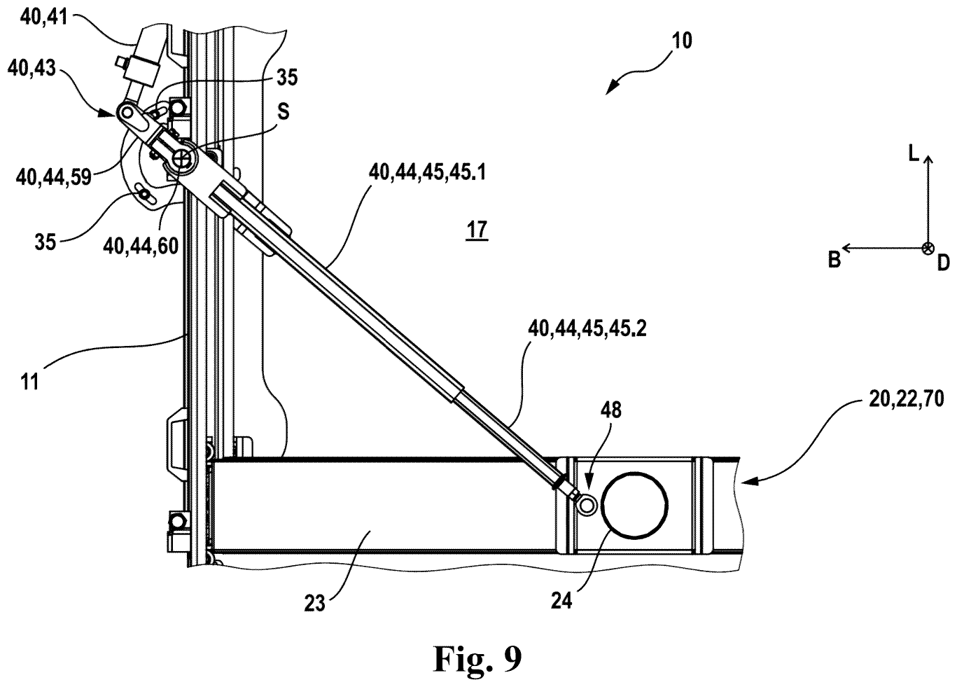

A suction runner arm 45 of the coupling lever 44 and a shielding runner arm 55 of the coupling lever 44 are connected in a rotationally fixed manner to the actuator arm 59 via the axle pin 60. The suction runner arm 45 has a displacement element 47 at its end which interacts with a guide element 26 in the central area 20.1 of the suction runner unit 20. The guide element 26 defines a guide path for the displacement element 47 running parallel to the width direction B. The shielding runner arm 55 has a similar displacement element 57 at its end which interacts with a guide element 36 in the central section 30.1 of the shielding runner unit 30. The guide element 36 here too defines a guide path for the displacement element 57 running parallel to the width direction B. In this embodiment, the respective displacement element 47, 57 is pivotably connected to the associated runner arm 45, 55. By displacing the respective displacement element 47, 57 relative to the guide element 26, 36, the pivoting movement of the respective runner arm 45, 55 can be transmitted into the translational movement of the respective runner unit 20, 30. The actuator 41 is controlled so that it alternately expands and contracts, resulting in an oscillating pivoting movement of the coupling lever 44. Actuator 41 should be controlled so that suction unit 22 reliably reaches both a first end position, shown by solid lines in FIG. 2, and a second end position, shown by dashed lines. For this purpose, sensors 35 (shown in FIG. 9) connected to the frame 11 in a stationary manner can detect positions of the actuator arm 59 that correspond to the end positions mentioned.

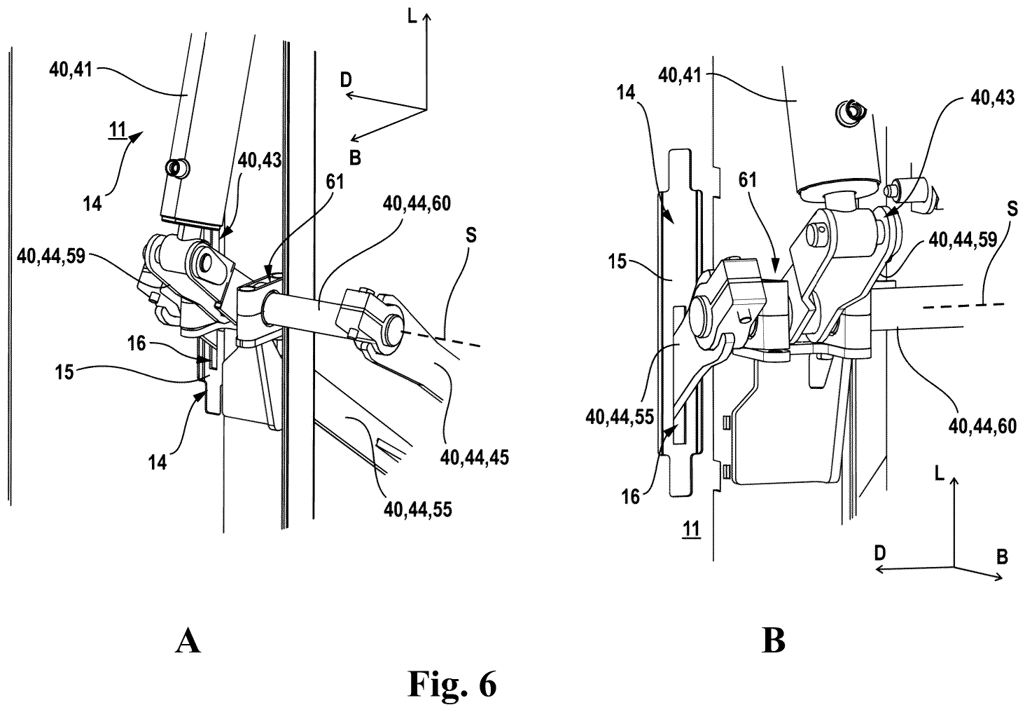

The pivot axis S of the coupling is offset in the width direction B to the screening chamber 17 and is arranged on an outside of the frame 11 opposite the screening chamber 17. The shielding runner unit 30 is arranged on the inside of the frame 11. While the suction runner arm 45 is guided past the frame on the ambient side U, the shielding runner arm 55 is guided through a frame port 14 in the frame 11. Since contaminants can in principle pass through this opening, a slider element 15 is arranged on the frame 11 so that it can be displaced in the running direction L. This partially covers the frame port 14, as can in particular be seen in FIGS. 6A and B. The slider element 15 has a slider port 16 through which the shielding runner arm 55 is guided. The slider port 16 has a smaller extension than the frame port 14 both in the running direction L and in the direction of passage D, thereby minimizing the risk of contamination of the radiator 6 and/or possible losses in cooling capacity. During the pivoting movement of the shielding runner arm 55, the slider element 15 is displaced in the running direction L so that the slider port 16 is always in the correct position. This also provides that the frame port 14 is always well sealed.

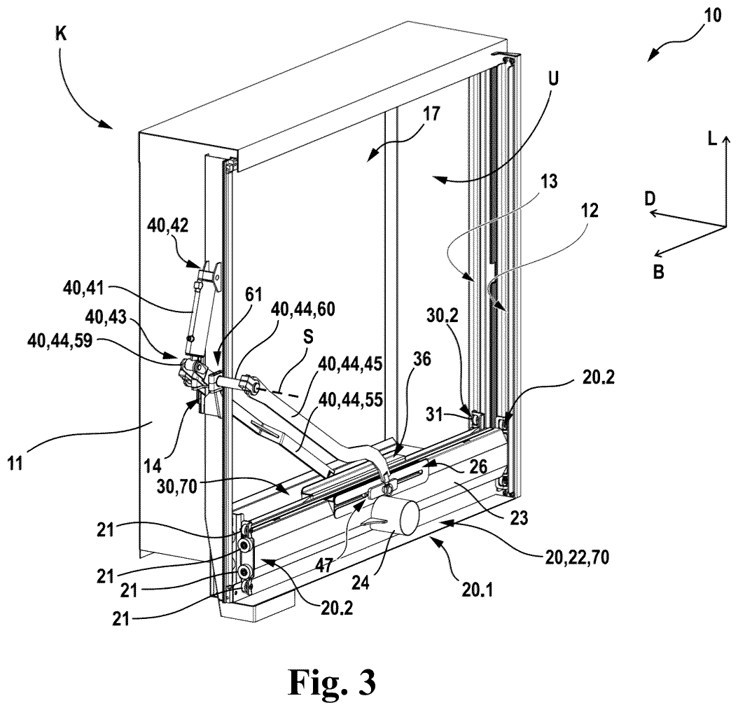

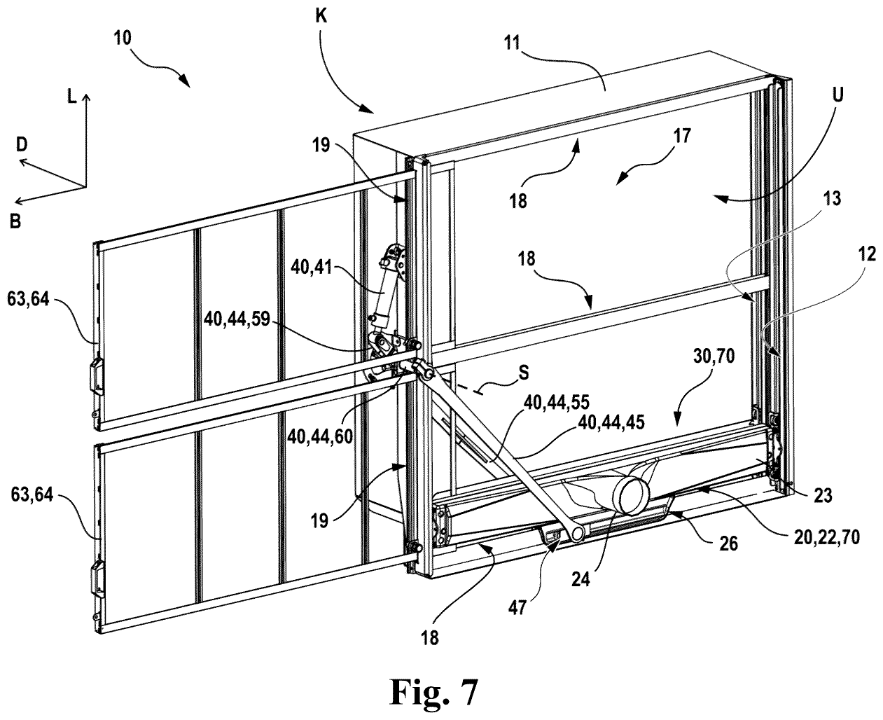

FIG. 7 shows a perspective illustration of a second embodiment of a radiator screen assembly 10 according to the present invention which substantially corresponds to the first embodiment. However, in this embodiment, the guide element 26 is arranged in front of the suction unit 22 with respect to the running direction L. In addition, in the illustration of the first embodiment in FIG. 3, part of the frame 11 which is shown in FIG. 7 has been omitted for better illustration. It can thus be seen that the frame 11 has two insertion openings 19 which extend longitudinally parallel to the running direction L. One insertion opening 19 is arranged in front of the axle pin 60 with respect to the running direction L and the other is arranged behind the axle pin 60. The insertion openings 19 are used to insert or remove two screen elements 64 of the screen 63. Due to their arrangement, there is no collision between the axle pin 60 and the screen elements 64. Within the frame 11, the screen elements 64 are guided via a rail-like screening guide 18, which has also been omitted in FIGS. 2-4 for reasons of clarity.

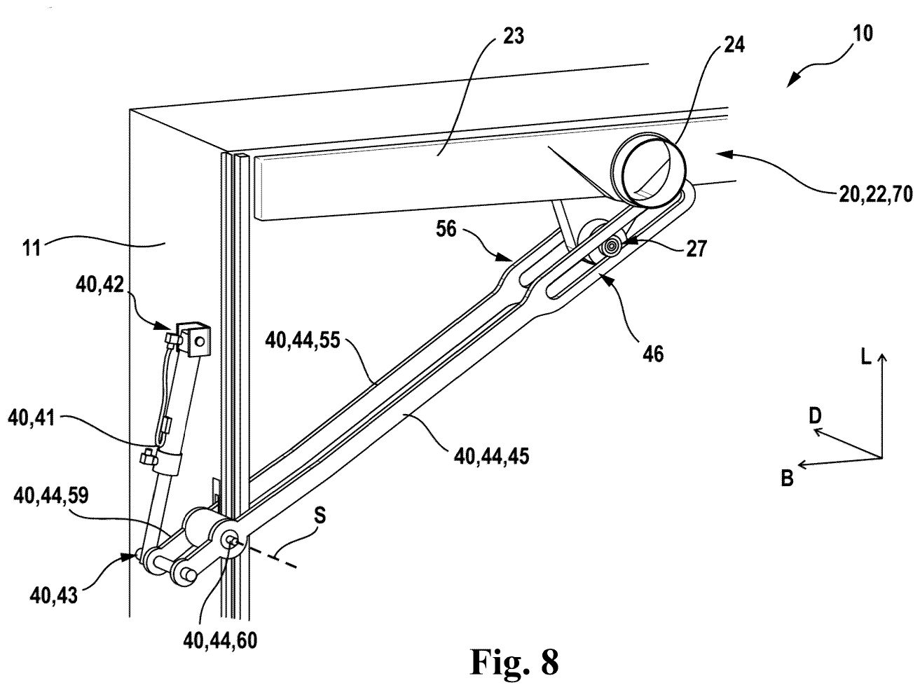

FIG. 8 shows part of a third embodiment of a radiator screen assembly 10 according to the present invention. This is largely identical to the first embodiment. In this case, however, the actuator arm 59 and the shielding runner arm 55 are designed as a single piece. The suction runner arm 45 and the shielding runner arm 55 additionally have guide elements 46, 56 designed as guide slots, while associated displacement elements 27 are arranged on the suction runner unit 20 and the shielding runner unit 30. The latter can be designed as rollers.

FIG. 9 shows part of a fourth embodiment of a radiator screen assembly 10 according to the present invention. This is again largely identical to the first embodiment. The suction runner arm 45 is, however, designed to be telescopic. An outer partial arm 45.1 is connected to the axle pin 60, while an inner partial arm 45.2, which is guided so as to be displaceable therein, is connected to the suction runner unit 20 via a pivot bearing of the runner arm 48. The shielding runner arm, which is not visible here, can have an analog or similar design.

The present invention is not limited to embodiments described herein; reference should be had to the appended claims.

### LIST OF REFERENCE CHARACTERS

1 Agricultural machine
2 Vehicle body
3 Harvesting header
4 Spout
5 Drive motor
6 Radiator
7 Vacuum source
10 Radiator screen assembly
11 Frame
12 First guide rail
13 Second guide rail
14 Frame port
15 Slider element
16 Slider port
17 Screening chamber
18 Screening guide
19 Insertion opening
20 Suction runner unit
20.1 Central section
20.2 Side section
21 Roller
22 Suction unit
23 Suction cover
24 Connecting piece
25 Brush element
26 Guide element
27 Displacement element
30 Shielding runner unit
30.1 Central section
30.2 Side section
31 Roller
32 Shielding element
35 Sensor
36 Guide element
40 Drive unit
41 Actuator
42 First actuator pivot bearing
43 Second actuator pivot bearing
44 Coupling lever
45 Suction runner arm
45.1 Outer partial arm
45.2 Inner partial arm
46 Guide element
47 Displacement element
48 Pivot bearing of the runner arm
55 Shielding runner arm
56 Guide element
57 Displacement element
59 Actuator arm
60 Axle pin
61 Pivot bearing of the coupling
63 Screen
64 Screen element
70 Cleaning unit
A Cooling air
B Width direction
D Direction of passage
E Screen level
K Radiator side
L Running direction
S Pivot axis of the coupling
U Ambient side
X Longitudinal axis
Y Transverse axis
Z Vertical axis

What is claimed is:

1-16. (canceled)

17. A radiator screen assembly for an agricultural machine, the radiator screen assembly comprising:
a frame;
a screening chamber which is at least partially surrounded by the frame, the screening chamber being configured to have a cooling air be passed therethrough in a direction of passage from an ambient side to a radiator side;
a screen arranged in the screening chamber to extend along a screen surface;
a cleaning unit which is configured to clean the screen, the cleaning unit comprising at least one runner unit which is mounted on the frame so as to be translationally displaceable along a running direction and so as to extend transversely to the running direction in a width direction; and
a drive unit which is configured to oscillate the at least one runner unit in the running direction, the drive unit comprising an actuator and a coupling lever which comprises at least one runner arm, the coupling lever being configured to pivot about a pivot axis of a coupling which is stationary relative to the frame and which is coupled to the actuator in an at least indirect drive-transmitting manner,
wherein,
at least one of the at least one runner arm of the coupling lever is coupled to the at least one runner unit in an at least indirect drive-transmitting manner.

18. The radiator screen assembly as recited in claim 17, wherein the pivot axis of the coupling is at least one of arranged offset with respect to the screening chamber and is arranged on an outside of the frame opposite to the screening chamber.

19. The radiator screen assembly as recited in claim 18, wherein the pivot axis of the coupling is arranged offset with respect to the screening chamber in the width direction.

20. The radiator screen assembly as recited in claim 17, wherein,
the at least one runner unit of the cleaning unit further comprises a suction runner unit,
the suction runner unit comprises a suction unit, and
the suction unit is arranged on the ambient side of the screen surface and is configured to connect to a vacuum source.

21. The radiator screen assembly as recited in claim 20, wherein the at least one runner arm of the coupling lever is arranged to extend on the ambient side of the screen surface and is coupled at least indirectly to the suction runner unit in a drive-transmitting manner.

22. The radiator screen assembly as recited in claim 20, wherein,
the at least one runner unit of cleaning unit further comprises a shielding runner unit,
the shielding runnier unit comprises a flat shielding element,
the flat shielding element is arranged opposite to the suction unit on the radiator side of the screen surface, and
a movement of the shielding runner unit along the running direction is positively coupled to a movement of the suction runner unit by the drive unit.

23. The radiator screen assembly as recited in claim 22, wherein
the at least one runner arm of the coupling lever comprises a shielding runner arm, and
the shielding runner arm is coupled to the shielding runner unit in an at least indirectly drive-transmitting manner.

24. The radiator screen assembly as recited in claim 23, wherein,
the at least one runner arm of the coupling lever further comprises a suction runner arm, and
the shielding runner arm is further coupled to the suction runner arm in a rotationally fixed manner.

25. The radiator screen assembly as recited in claim 23, wherein,
the frame comprises a frame port, and
one of the at least one runner arm is guided through the frame port in the frame.

26. The radiator screen assembly as recited in claim 25, further comprising:
a slider element arranged on the frame so as to be displaceable in the running direction, the slider element being configured to partially cover the frame port, the slider element comprising a slider port which is configured to have the at least one runner arm be guided therethrough.

27. The radiator screen assembly as recited in claim 17, wherein,
at least one of the at least one runner unit comprises side sections, and
a respective end of the at least one of the at least one runner unit is mounted on the frame via a respective one of the side sections with respect to the width direction.

28. The radiator screen assembly as recited in claim 17, wherein,
at least one of the at least one runner arm has one of the at least one runner unit associated therewith cooperate via a displacement element and a guide element, and
the guide element is configured to define a displacement path which extends at an angle to the running direction and along which the displacement element is displaceably guided.

29. The radiator screen assembly as recited in claim 17, wherein at least one of the at least one runner arm is designed telescopically, has one of the at least one runner unit associated therewith, and is connected to the one of the at least one runner unit associated therewith via a pivot bearing.

30. The radiator screen assembly as recited in claim 17, wherein,
the coupling lever further comprises an actuator arm, and
the actuator arm is connected in a rotationally fixed manner to the at least one runner arm and is coupled at least indirectly to the actuator.

31. The radiator screen assembly as recited in claim 30, wherein the actuator is a linear actuator.

32. The radiator screen assembly as recited in claim 31, wherein the linear actuator is pivotably connected to the frame and is pivotably connected to the actuator arm.

33. The radiator screen assembly as recited in claim 17, wherein,
the frame comprises at least one lateral insertion opening,
the screen comprises at least one screen element, and
the at least one lateral insertion opening is configured to introduce the at least one screen element of the screen into the screening chamber.

34. The radiator screen assembly as recited in claim 33, wherein the at least one lateral insertion opening is arranged laterally in the width direction and extends in the running direction.

35. The radiator screen assembly as recited in claim 33, wherein,
the at least one lateral insertion opening is provided as two insertion openings,
the two insertion openings are arranged offset relative to one another in the running direction, and
the pivot axis of the coupling is arranged between the two insertion openings with respect to the running direction.

36. An agricultural machine comprising a radiator screen assembly, the radiator screen assembly comprising:
a frame;
a screening chamber which is at least partially surrounded by the frame, the screening chamber being configured to have a cooling air be passed therethrough in a direction of passage from an ambient side to a radiator side;
a screen arranged in the screening chamber to extend along a screen surface;
a cleaning unit which is configured to clean the screen, the cleaning unit comprising at least one runner unit which is mounted on the frame so as to be translationally displaceable along a running direction and so as to extend transversely to the running direction in a width direction; and
a drive unit which is configured to oscillate the at least one runner unit in the running direction, the drive unit comprising an actuator and a coupling lever which comprises at least one runner arm, the coupling lever being configured to pivot about a pivot axis of a coupling which is stationary relative to the frame and which is coupled to the actuator in an at least indirect drive-transmitting manner,
wherein,
at least one of the at least one runner arm of the coupling lever is coupled to the at least one runner unit in an at least indirect drive-transmitting manner.
